(19) United States
(12) Patent Application Publication
(10) Pub. No.: US 2006/0151580 A1
(43) Pub. Date: Jul. 13, 2006

(54) Coating compositions for solder spheres, powders and preforms, methods of production and uses thereof

(76) Inventor: James Flint, Mead, WA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/534,954

(22) PCT Filed: Nov. 13, 2003
(86) PCT No.: PCT/US03/37663

§ 371 Date: Oct. 17, 2005

Related U.S. Application Data
(60) Provisional application No. 60/427,597, filed on Nov. 18, 2002.

(51) Int. Cl. B23K 3/06

(52) U.S. Cl. 228/244

(57) ABSTRACT

A solder material has been produced and is described herein that comprises a conventional solder component, such as a solder sphere, solder ball, solder powder, solder preform, some other suitable material or form of solder or a combination thereof and a coating composition. Solder parts and/or solder materials described herein may be produced by a) providing a solder component, b) providing a coating precursor material, c) providing a solvent, d) blending the coating precursor material and the solvent, such that the coating precursor material is substantially solvated, to form a coating composition, and e) applying or coupling the coating composition to the solder component.

This application claims the benefit of U.S. Provisional application No. 60/427,597 filed on Nov. 18, 2002, incorporated herein by reference in it's entirety.

### FIELD OF THE INVENTION

The field of the invention is thermal interface and thermal management components for electronic and semiconductor applications.

### BACKGROUND

Electronic components are used in ever increasing numbers of consumer and commercial electronic products. Examples of some of these consumer and commercial products are televisions, personal computers, internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

Components, therefore, are being broken down and investigated to determine if there are better building materials, machinery and methods that will allow them to be scaled down to accommodate the demands for smaller electronic components. Part of the process of determining if there are better building materials, machinery and methods is to investigate how the manufacturing equipment and methods of building and assembling the components operates.

For those components that require solder, the manufacturing equipment utilizes solder spheres, balls, powder, performs or some other solder component or solder part to form the liquefied or compliant solder material. Solder parts may darken with excessive vibration caused by transportation or the manufacturing equipment using the parts. For solder spheres, excessive darkening from surface oxide and other contaminant processes creates difficulties for imaging systems in the manufacturing equipment, which may mistake a dark solder sphere for a missing solder sphere. This mistake can lead the component to which the solder sphere is attached to be rejected and ultimately the cost of production will increase. Furthermore, if the surface oxide is thick enough, the part may become hard to solder and/or the ultimate solder point may be weakened by the chemical contaminants.

There are several references, including U.S. Pat. Nos. 5,789,068 and 6,387,499 and WO 00/74132, that are directed at using fluoropolymers, hydrocarbon-based compounds, oils, lubricants and polymers and organosiloxane-based oils, however, in each of these cases the coating cannot sufficiently burn off during solder reflow, which leaves deleterious residues, causes smoking or fuming or could possibly leach hazardous gases into the atmosphere, as in the case of fluoropolymers.

Thus, there is a continuing need to: a) design and produce solder materials that meet customer specifications while minimizing the production costs and maximizing the quality of the product incorporating the solder materials; and b) develop reliable methods of producing solder materials and components comprising those solder materials. There is also a need to design coating compositions that comprise polymers, and in some cases, monomers that can be considered to be a) soluble, b) a suitable material to form a thin coating on a metal or metal alloy surface, c) a suitable material to aid in the resistance of surface oxidation of the metal, d) a suitable material that will break down upon application of heat to the point where any remnants of the material will not degrade the performance of the solder material, and e) a material that will be substantially transparent when applied to a metal surface, wherein the coating composition or material will evaporate and/or break down to the point where it can be easily removed or expelled from the heated solder material when the solder material is heated to the melt point or point where it becomes compliant.

### SUMMARY OF THE SUBJECT MATTER

A solder material has been produced and is described herein that comprises a conventional solder component, such as a solder sphere, solder ball, solder powder, solder preform, some other suitable material or form of solder or a combination thereof and a coating composition that comprises at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof.

Solder parts and/or solder materials described herein may be produced by a) providing a solder component, b) providing a coating precursor material, c) providing a solvent, d) blending the coating precursor material and the solvent, such that the coating precursor material is substantially solvated, to form a coating composition, wherein the coating composition comprises at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof, and e) applying or coupling the coating composition to the solder component.

A solder material has been produced and is described herein that comprises a conventional solder component, such as a solder sphere, solder ball, solder powder, solder preform, some other suitable material or form of solder or a combination thereof, an adhesion promoter and a coating composition that comprises at least one monomer, polymer or a combination thereof.

Solder parts and/or solder materials described herein may be produced by a) providing a solder component, b) providing a coating precursor material, c) providing a solvent, d) providing an adhesion promoter compound; e) blending the coating precursor material and the solvent, such that the coating precursor material is substantially solvated, to form a coating composition, f) applying the adhesion promoter to the solder component and f) applying or coupling the coating composition to the solder component.

Solder parts and/or solder materials described herein may be produced by a) providing a solder component, b) providing a coating precursor material, c) providing a solvent, d) providing an adhesion promoter compound; e) blending the coating precursor material and the solvent, such that the coating precursor material is substantially solvated, f) blending the adhesion promoter into the coating precursor material and solvent to form a coating composition and f) applying or coupling the coating composition to the solder component.

### DETAILED DESCRIPTION

As mentioned, surface oxidation and darkening behavior and/or rate can occur naturally and/or can be accelerated through vibration testing or transportation of the solder material or solder parts. For example, lead-containing parts can reach an unacceptable darkness level in 15 to 20 minutes of accelerated vibration testing.

Solder materials, as described herein, have been designed and produced that can meet a customer's specifications while minimizing the production costs and maximizing the quality of the product incorporating the solder materials, and methods of producing those solder materials and components comprising those solder materials are also described herein. In addition, coating compositions that comprise polymers, and in some cases, monomers are described, wherein the constituents are a) soluble, b) suitable materials to form a thin coating on a metal or metal alloy surface, c) suitable materials to aid in the resistance of surface oxidation of the metal, d) suitable materials that will break down upon application of heat to the point where any remnants of the material will not degrade the performance of the solder material, and e) materials that are substantially transparent when applied to a metal surface, wherein the coating composition or material evaporates and/or breaks down to the point where it can be easily removed or expelled from the heated solder material when the solder material is heated to the melt point or point where it becomes compliant.

A solder material has been produced and is described herein that comprises a conventional solder component, such as a solder sphere, solder ball, solder powder, solder preform, some other suitable material or form of solder or a combination thereof and a coating composition that not only protects the solder material, but also minimizes surface oxidation and contamination, minimizes production costs and maximizes the quality of the final product that incorporates the solder material. The coating compositions contemplated herein comprises at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof.

In contemplated embodiments, the solder component comprises a melting temperature, the coating composition comprises a thermal degradation temperature, and the thermal degradation temperature is less than the melting temperature. As used herein, the “melting temperature” of the solder component is that temperature where the solid solder component turns to a liquid or semi-solid material. The “melting temperature” may be a range of temperatures where the solid solder material turns semi-solid at one temperature and then turns to liquid at a higher temperature. The “thermal degradation temperature” for the coating composition is that temperature where the components of the coating composition begin to break apart and disintegrate causing at least partial deterioration of the coating composition.

By applying a thin protective coating, the surface oxidation and darkening behavior or rate is minimized and/or completely eliminated. The application of a thin coating of material results in a product that a) does not excessively darken, b) meets the needs of imaging systems in manufacturing equipment, and c) does not hinder the solder material's or solder part's performance. In addition, by applying a coating composition to solder parts, solder materials and other solder components, accelerated vibration testing and in some necessary cases, more aggressive testing of the solder components, parts and materials can take place with decreased surface oxidation and/or darkening behavior. It has been surprisingly found that solder parts, solder materials and other solder components that have been treated with a coating composition do not exceed the darkness level until after four hours of accelerated testing; and for lead-free parts, the unacceptable darkness level is not reached even after 10 hours of accelerated testing.

Contemplated solder components may comprise any suitable solder material or metal, such as indium, lead, silver, copper, aluminum, tin, bismuth, gallium and alloys thereof, silver coated copper, silver coated aluminum and combinations thereof or with other metals, as described below. Preferred solder materials may comprise lead-tin alloys, including a lead (37%)-tin (63%) eutectic alloy, indium tin (InSn) compounds and alloys, indium silver (InAg) compounds and alloys, indium-based compounds, tin silver copper compounds (which already comprise copper) and alloys (SnAgCu), tin bismuth compounds and alloys (SnBi), and aluminum-based compounds and alloys. As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include such as indium, lead, silver, copper, aluminum, tin, bismuth, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes.

The coating compositions contemplated herein generally comprise polymers, and in some cases, monomers that can be considered to be a) soluble, b) a suitable material to form a thin coating on a metal or metal alloy surface, c) a suitable material to aid in the resistance of surface oxidation of the metal, d) a suitable material that will break down upon application of heat to the point where any remnants of the material will not degrade the performance of the solder material, and e) a material that will be substantially transparent when applied to a metal surface. As mentioned earlier, some contemplated coating compositions will comprise at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof.

In contemplated embodiments, the coating composition or material will evaporate and/or break down to the point where it can be easily removed or expelled from the heated solder material when the solder material is heated to the melt point or point where it becomes compliant. Some contemplated coating compositions comprise polymers, such as polycarbonate, polyamides or nylon-based compounds, polyethylene terphthalate or any polymer that can be dissolved in a solvent and will give a transparent appearance coating on the solder part or material surface. The coating composition may be colored or opaque, but should still have a generally transparent appearance with whatever thickness is being utilized. It should be understood that the coating composition should be transparent or relatively transparent, such that the solder parts, solder materials and/or solder compositions start out as bright and shiny as possible.

Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Dalton and 400000 Dalton or more.

Other contemplated coating precursor compositions may comprise inorganic-based compounds, such as silicon-based chemistries, such as those comprising hydridosiloxane groups, disclosed in commonly assigned U.S. Pat. No. 6,143,855 and pending U.S. Ser. No. 10/078,919 filed Feb. 19, 2002; (for example Honeywell NANOGLASS® and HOSP® products), gallium-based, germanium-based, arsenic-based, boron-based compounds or combinations thereof, and organic-based compounds, such as polyethers, polyarylene ethers disclosed in commonly assigned U.S. Pat. No. 6,124,421 (such as Honeywell FLARE™ product), polyimides, polyesters and adamantane-based or cage-based compounds disclosed in commonly assigned WO 01/78110 and WO 01/08308 (such as Honeywell GX-3™ product).

Polymers, such as linear polymer, star polymers, cross-linked polymeric nanospheres, block copolymers, and hyperbranched polymers may be used in contemplated embodiments with the solder materials. Suitable linear polymers are polyethers, such as poly(ethylene oxide) and poly(propylene oxide); polyacrylates such as poly(methylmethacrylate); aliphatic polycarbonates such as poly(propylene carbonate) and poly(ethylene carbonate); polyesters; polysulfones; polystyrene that include monomer units selected from halogenated styrene and hydroxy-substituted styrene); and other vinyl-based polymers. Useful polyester polymers include polycaprolactone; polyethylene terephthalate; poly(oxyadipoyloxy-1,4-phenylene); poly(oxyterephthaloyloxy-1,4-phenylene); poly(oxyadipoyloxy-1,6-hexamethylene); polyglycolide, polylactide (polylactic acid), polylactide-glycolide, polypyruvic acid, polycarbonate such as poly(hexamethylene carbonate) diol having a molecular weight from about 500 to about 2500; and polyether such as poly(bisphenol A-co-epichlorohydrin) having a molecular weight from about 300 to about 6500. Suitable crosslinked, insoluble nanospheres (prepared as nanoemulsions) are suitably comprised of polystyrene or poly(methylmethacrylate). Suitable block copolymers are poly-glycolids, polylacetic acid, poly(styrene-co-α-methylstyrene, poly(styrene-ethylene oxide), poly(etherlactones), poly(estercarbonates) and poly(lactonelactide). Suitable hyperbranched polymers are hyperbranched polyester, e.g. hyperbranched poly(caprolactone), and polyethers such as polyethylene oxide and polypropylene oxide. Another useful polymer is ethylene glycol-poly(caprolactone). Useful polymer blocks include polyvinylpyridines, hydrogenated polyvinyl aromatics, polyacrylonitriles, polysiloxanes, polycaprolactams, polyurethanes, polyvinyl chlorides, polyacetals and amine-capped alkylene oxides. Other useful thermoplastic materials include polytetrahydrofurans and polyethyloxazolines.

Other suitable polymers include those which contain one or more reactive groups, such as hydroxyl or amino. Within these general parameters, a suitable polymer for use in the compositions and methods disclosed herein is, e.g. a polyalkylene oxide, a monoether of a polyalkylene oxide, a diether of a polyalkylene oxide, bisether of a polyalkylene oxide, an aliphatic polyester, an acrylic polymer, an acetal polymer, a poly(caprolactone), a poly(valeractone), a poly(methlymethoacrylate), a poly(vinylbutyral) and/or combinations thereof. When the polymer is a polyalkylene oxide monoether, one particular embodiment is a C₁ to about C₆ alkyl chain between oxygen atoms and a C₁ to about C₆ alkyl ether moiety, and wherein the alkyl chain is substituted or unsubstituted, e.g., polyethylene glycol monomethyl ether, polyethylene glycol dimethyl ether, or polypropylene glycol monomethyl ether.

Contemplated polymers may also comprise at least two fused aromatic rings wherein each of the fused aromatic rings has at least one alkyl substituent thereon and a bond exists between at least two of the alkyl substituents on adjacent aromatic rings may be used in contemplated embodiments. Preferred polymers in this class of polymers include unfunctionalized polyacenaphthylene homopolymer, functionalized polyacenaphthylene homopolymer, the polyacenaphthylene copolymers described below, poly(2-vinylnaphthalene) and vinyl anthracene, and blends with each other. Other useful coating precursor compositions comprise adamantane, diamantane, fullerene and polynorbornene. Each of these precursor materials, including those listed above, may be blended with one another or other coating precursor material, such as polycaprolactone, polystyrene and polyester. Useful blends include unfunctionalized polyacenaphthylene homopolymer and polycaprolactone. Other contemplated coating precursor compositions include unfunctionalized polyacenaphthylene homopolymer, functionalized polyacenaphthylene homopolymer, polyacenaphthylene copolymer and polynorbornene.

Useful polyacenaphthylene homopolymers may have weight average molecular weights ranging from preferably about 300 to about 20,000; more preferably about 300 to about 10,000; and most preferably about 1000 to about 7000 and may be polymerized from acenaphthylene using different initiators such as 2,2′-azobisisobutyronitrile (AIBN); di-tert-butyl azodicarboxylate; di-phenylazodicarboxylate; 1,1′-azobis(cyclohezanecarbonitrile); benzoyl peroxide (BPO); t-butyl peroxide; and boron trifluoride diethyl etherate. The polyacenaphthylene homopolymer may have functional end groups such as triple bonds or double bonds to the chain end or cationic polymerization quenched with a double or triple bond alcohol, such as allyl alcohol, propargyl alcohol, butynol, butenol or hydroxyethylmethacrylate.

Useful polyacenaphthylene copolymers may be linear polymers, star polymers or hyperbranched polymers. The comonomer may have a bulky side group that will result in copolymer conformation that is similar to that of polyacenaphthylene homopolymer or a nonbulky side group that will result in copolymer conformation that is dissimilar to that of polyacenaphthylene homopolymer. Comonomers having a bulky side group include vinyl pivalate; tert-butyl acrylate; styrene; α-methylstyrene; tert-butylstyrene; 2-vinylnaphthalene; 5-vinyl-2-norbornene; vinyl cyclohexane; vinyl cyclopentant; 9-vinylanthracene; 4-vinylbiphenyl; tetraphenylbutadiene; stilbene; tert-butylstilbene; and indene; and preferably vinyl pivalate. Hydridopolycarbosilane may be used as an additional co-monomer or copolymer component with acenaphthylene and at least one of the preceding comonomers. An example of a useful hydridopolycarbosilane has 10% or 75% allyl groups. Comonomers having a nonbulky side group include vinyl acetate, methyl acrylate, methyl methacrylate, and vinyl ether and preferably vinyl acetate.

As used herein, the term “monomer” refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. Monomers may belong to various chemical classes of molecules including organic, organometallic or inorganic molecules. The molecular weight of monomers may vary greatly between about 40 Dalton and 20000 Dalton. However, especially when monomers comprise repetitive building blocks, monomers may have even higher molecular weights. Monomers may also include additional groups, such as groups used for crosslinking.

Solder parts and/or solder materials described herein may be produced by a) providing a solder component, b) providing a coating precursor material, c) providing a solvent, d) blending the coating precursor material and the solvent, such that the coating precursor material is substantially solvated, to form a coating composition, wherein the coating composition comprises non-fluorinated polymers, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof, and e) applying or coupling the coating composition to the solder component. Once the coating composition is applied or coupled to the solder component, the coating composition may be dried, cured or otherwise treated in order to form a solder component coating.

As used herein, the term “coupled” means that the surface and layer or two layers are physically attached to one another or there's a physical attraction between two parts of matter or components, including bond forces such as covalent and ionic bonding, and non-bond forces such as Van der Waals, electrostatic, coulombic, hydrogen bonding and/or magnetic attraction. Also, as used herein, the term coupled is meant to encompass a situation where the surface of the solder material and the coating composition are directly attached to one another, but the term is also meant to encompass the situation where the surface of the solder material and the coating composition are coupled to one another indirectly—such as the case where there's an adhesion promoter layer between the surface of the solder material and the coating composition or where there's another layer altogether between the surface of the solder material and the coating composition.

The coating precursor material comprises the polymers and/or monomers previously described herein. In some embodiments, the coating precursor material is provided in a weight volume of about 1000 ppm coating precursor material in the solvent. In other embodiments, the coating precursor material is provided in a weight volume of less than about 1000 ppm coating precursor material in the solvent. In yet other embodiments, the coating precursor material is provided in a weight volume of greater than about 1000 ppm coating precursor material in the solvent. The weight volume of coating precursor material is determined by several factors, including a) the composition of the coating precursor material, b) the solvent, c) the solder material, and d) the intended use of the coated solder material.

Contemplated solvents include any suitable pure or mixture of organic molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosene, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof.

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. In yet other contemplated embodiments, the solvent or solvent mixture may comprise a combination of any of the solvents mentioned herein.

The solder component, the solvent and/or the coating precursor material may be provided by any suitable method, including a) buying at least some of the solder component, the solvent and/or the coating precursor material from a supplier; b) preparing or producing at least some of the solder component, the solvent and/or the coating precursor material in house using chemicals provided by another source and/or c) preparing or producing at least some of the solder component, the solvent and/or the coating precursor material in house using chemicals also produced or provided in house or at the location. In some embodiments, a suitable coating composition, which may have otherwise been used for other applications not related to solder materials, may be purchased in a form whereby the coating composition just needs to be applied to the solder material and then dried, cured or otherwise treated to form a solder coating.

Once the solvent and/or the coating precursor material are provided, they are blended to form a composition, wherein the composition constituents are at a suitable viscosity to coat the solder material. Blending the constituents may be achieved by utilizing any suitable method or methods known in the art, such as mixing, stirring, shaking or a combination thereof. It is contemplated that the solder material and the coating composition may be coupled by any suitable method, including by dipping the solder material into the coating composition, pouring the coating composition onto the solder material, vapor deposition of the coating composition onto the solder material and the like.

As mentioned, once the coating composition is applied or coupled to the solder component, it may be dried, cured or otherwise treated in order to form a solder component coating. Drying and/or curing the coating composition may be as simple as allowing the solvent to evaporate from the composition naturally (without thermal energy) or could comprise exposing the coating composition to a thermal energy in order to drive off the solvent. The thermal energy may come from any suitable source, including extended/non-point sources, such as a UV-VIS source, an infra-red source, a heat source, both radiative and convective, or a microwave source; or electron sources, such as electron guns or plasma sources. Other suitable energy sources include electron beams, and radiative devices at non-IR wavelengths including x-ray, and gamma ray. Still other suitable energy sources include vibrational sources such as microwave transmitters. In preferred embodiments, the energy source is an extended source.

Also, in some embodiments, additives such as adhesion promoters and other adhesive additives may be added to the coating precursor material to promote adhesion to the solder temperature required to melt solder material or make the solder material compliant, as long as the general objectives of the coating composition are met. The phrase “adhesion promoter” as used herein means any component that when used with the thermally degradable polymer or coating composition, improves the adhesion thereof to substrates compared with thermally degradable polymers and/or the coating composition by itself. Preferably the at least one adhesion promoter is used with the thermally degradable polymer. The adhesion promoter may be a co-monomer reacted with the thermally degradable polymer precursor or an additive to the thermally degradable polymer precursor. Examples of useful adhesion promoters are disclosed in commonly assigned pending US Application Serial Number 158513 filed May 30, 2002 incorporated herein in its entirety.

Adhesion promoters contemplated herein may comprise compounds having at least bifunctionality wherein the bifunctionality may be the same or different and at least one of the first functionality and the second functionality is selected from the group consisting of Si-containing groups; N-containing groups; C bonded to O-containing groups; hydroxyl groups; and C double bonded to C-containing groups. The phrase “compound having at least bifunctionality” as used herein means any compound having at least two functional groups capable of interacting or reacting, or forming bonds as follows. The functional groups may react in numerous ways including addition reactions, nucleophilic and electrophilic substitutions or eliminations, radical reactions, etc. Further alternative reactions may also include the formation of non-covalent bonds, such as Van der Waals, electrostatic bonds, ionic bonds, and hydrogen bonds.

In some embodiments of the at least one adhesion promoter, preferably at least one of the first functionality and the second functionality is selected from Si-containing groups; N-containing groups; C bonded to O-containing groups; hydroxyl groups; and C double bonded to C-containing groups. Preferably, the Si-containing groups are selected from Si—H, Si—O, and Si—N; the N-containing groups are selected from such as C—NH₂ or other secondary and tertiary amines, imines, amides, and imides; the C bonded to O-containing groups are selected from ═CO, carbonyl groups such as ketones and aldehydes, esters, —COOH, alkoxyls having 1 to 5 carbon atoms, ethers, glycidyl ethers; and epoxies; the hydroxyl group is phenol; and the C double bonded to C-containing groups are selected from allyl and vinyl groups. For semiconductor applications, the more preferred functional groups include the Si-containing groups; C bonded to O-containing groups; hydroxyl groups; and vinyl groups.

Contemplated adhesion promoters may also comprise an organic resin-based material that further comprises phenolic-containing resins, novolac resins, such as CRJ-406 or HRJ-11040 (both from Schenectady International, Inc.), organic acrylate and/or a styrene resins. Other adhesion promoters may comprise polydimethylsiloxane materials, ethoxy or hydroxy-containing silane monomers, vinyl-containing silane monomers, acrylated silane monomers, or silyl hydrides.

An example of a contemplated adhesion promoter having Si-containing groups is silanes of the Formula I: (R₁₄)ₖ(R₁₅)ₗSi(R₁₆)ₘ(R₁₇)ₙ wherein R₁₄, R₁₅, R₁₆, and R₁₇ each independently represents hydrogen, hydroxyl, unsaturated or saturated alkyl, substituted or unsubstituted alkyl where the substituent is amino or epoxy, saturated or unsaturated alkoxyl, unsaturated or saturated carboxylic acid radical, or aryl; at least two of R₁₄, R₁₅, R₁₆, and R₁₇ represent hydrogen, hydroxyl, saturated or unsaturated alkoxyl, unsaturated alkyl, or unsaturated carboxylic acid radical; and k+l+m+n≧4. Examples include vinylsilanes such as H₂C═CHSi(CH₃)₂H and H₂C═CHSi(R₁₈)₃ where R₁₈ is CH₃O, C₂H₅O, AcO, H₂C═CH, or H₂C═C(CH₃)O—, or vinylphenylmethylsilane; allylsilanes of the formula H₂C═CHCH₂—Si(OC₂H₅)₃ and H₂C═CHCH₂—Si(H)(OCH₃)₂; glycidoxypropylsilanes such as (3-glycidoxypropyl)methyldiethoxysilane and (3-glycidoxypropyl)trimethoxysilane; methacryloxypropylsilanes of the formula H₂C═(CH₃)COO(CH₂)₃—Si(OR₁₉)₃ where R₁₉ is an alkyl, preferably methyl or ethyl; aminopropylsilane derivatives including H₂N(CH₂)₃Si(OCH₂CH₃)₃, H₂N(CH₂)₃Si(OH)₃ or H₂N(CH₂)₃OC(CH₃)₂CH═CHSi(OCH₃)₃. The aforementioned silanes are commercially available from Gelest.

An example of a contemplated adhesion promoter having C bonded to O-containing groups is glycidyl ethers including but not limited to 1,1,1-tris-(hydroxyphenyl)ethane tri-glycidyl ether which is commercially available from TriQuest.

An example of a contemplated adhesion promoter having C bonded to O-containing groups is esters of unsaturated carboxylic acids containing at least one carboxylic acid group. Examples include trifunctional methacrylate ester, trifunctional acrylate ester, trimethylolpropane triacrylate, dipentaerythritol pentaacrylate, and glycidyl methacrylate. The foregoing are all commercially available from Sartomer.

An example of a contemplated adhesion promoter having vinyl groups is vinyl cyclic pyridine oligomers or polymers wherein the cyclic group is pyridine, aromatic, or heteroaromatic. Useful examples include but not limited to 2-vinylpyridine and 4-vinylpyridine, commercially available from Reilly; vinyl aromatics; and vinyl heteroaromatics including but not limited to vinyl quinoline, vinyl carbazole, vinyl imidazole, and vinyl oxazole.

An example of another contemplated adhesion promoter having Si-containing groups is the polycarbosilane disclosed in commonly assigned copending allowed U.S. patent application Ser. No. 09/471,299 filed Dec. 23, 1999 incorporated herein by reference in its entirety. The polycarbosilane is that shown in Formula II: 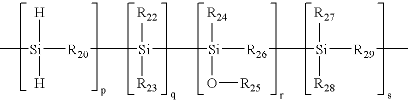
in which R₂₀, R₂₆, and R₂₉ each independently represents substituted or unsubstituted alkylene, cycloalkylene, vinylene, allylene, or arylene; R₂₁, R₂₂, R₂₃, R₂₄, R₂₇, and R₂₈ each independently represents hydrogen atom or organo group comprising alkyl, alkylene, vinyl, cycloalkyl, allyl, or aryl and may be linear or branched; R₂₅ represents organosilicon, silanyl, siloxyl, or organo group; and p, q, r, and s satisfy the conditions of [4≦p+q+r+s≦100,000], and q and r and s may collectively or independently be zero. The organo groups may contain up to 18 carbon atoms but generally contain from about 1 to about 10 carbon atoms. Useful alkyl groups include —CH₂— and —(CH₂)ₜ— where t>1.

Contemplated polycarbosilanes include dihydridopolycarbosilanes in which R₂₀ is a substituted or unsubstituted alkylene or phenyl, R₂₁ group is a hydrogen atom and there are no appendent radicals in the polycarbosilane chain; that is, q, r, and s are all zero. Another preferred group of polycarbosilanes are those in which the R₂₁, R₂₂, R₂₃, R₂₄, R₂₅, and R₂₉ groups of Formula II are substituted or unsubstituted alkenyl groups having from 2 to 10 carbon atoms. The alkenyl group may be ethenyl, propenyl, allyl, butenyl or any other unsaturated organic backbone radical having up to 10 carbon atoms. The alkenyl group may be dienyl in nature and includes unsaturated alkenyl radicals appended or substituted on an otherwise alkyl or unsaturated organic polymer backbone. Examples of these preferred polycarbosilanes include dihydrido or alkenyl substituted polycarbosilanes such as polydihydridocarbosilane, polyallylhydrididocarbosilane and random copolymers of polydihydridocarbosilane and polyallylhydridocarbosilane.

In the more preferred polycarbosilanes, the R₂₁ group of Formula II is a hydrogen atom and R₂₁ is methylene and the appendent radicals q, r, and s are zero. Other preferred polycarbosilane compounds of the invention are polycarbosilanes of Formula II in which R₂, and R₂₇ are hydrogen, R₂₀ and R₂₉ are methylene, and R₂₈ is an alkenyl, and appendent radicals q and r are zero. The polycarbosilanes may be prepared from well known prior art processes or provided by manufacturers of polycarbosilane compositions. In the most preferred polycarbosilanes, the R₂₁ group of Formula II is a hydrogen atom; R₂₄ is —CH₂—; q, r, and s are zero and p is from 5 to 25. These most preferred polycarbosilanes may be obtained from Starfire Systems, Inc.

As can be observed in Formula II, the polycarbosilanes utilized may contain oxidized radicals in the form of siloxyl groups when r>0. Accordingly, R₂₅ represents organosilicon, silanyl, siloxyl, or organo group when r>0. It is to be appreciated that the oxidized versions of the polycarbosilanes (r>0) operate very effectively in, and are well within the purview of the present invention. As is equally apparent, r can be zero independently of p, q, and s the only conditions being that the radicals p, q, r, and s of the Formula II polycarbosilanes must satisfy the conditions of [4<p+q+r+s<100,000], and q and r can collectively or independently be zero.

The polycarbosilane may be produced from starting materials that are presently commercially available from many manufacturers and by using conventional polymerization processes. As an example of synthesis of the polycarbosilanes, the starting materials may be produced from common organo silane compounds or from polysilane as a starting material by heating an admixture of polysilane with polyborosiloxane in an inert atmosphere to thereby produce the corresponding polymer or by heating an admixture of polysilane with a low molecular weight carbosilane in an inert atmosphere t o thereby produce the corresponding polymer or by heating an admixture of polysilane with a low molecular carbosilane in an inert atmosphere and in the presence of a catalyst such as polyborodiphenylsiloxane to thereby produce the corresponding polymer. Polycarbosilanes may also be synthesized by Grignard Reaction reported in U.S. Pat. No. 5,153,295 hereby incorporated by reference in its entirety.

An example of a contemplated adhesion promoter having hydroxyl groups is phenol-formaldehyde resins or oligomers of the Formula III: —[R₃₀C₆H₂(OH)(R₃₁)]ᵤ— where R₃₀ is substituted or unsubstituted alkylene, cycloalkylene, vinyl, allyl, or aryl; R₃₁ is alkyl, alkylene, vinylene, cycloalkylene, allylene, or aryl; and u=3-100. Examples of useful alkyl groups include —CH₂— and —(CH₂)ᵥ— where v>1. A particularly useful phenol-formaldehyde resin oligomer has a molecular weight of 1500 and is commercially available from Schenectady International Inc.

In some contemplated embodiments, the adhesion promoter is added in small, but effective amounts preferably from about 0.01% up to about 15% and more preferably from about 0.05% to about 7% based on the weight of the coating composition.

A contemplated solder material comprises a conventional solder component, such as a solder sphere, solder ball, solder powder, solder preform, some other suitable material or form of solder or a combination thereof, an adhesion promoter and a coating composition that comprises at least one monomer, polymer or a combination thereof.

Solder parts and/or solder materials contemplated herein may be produced by a) providing a solder component, b) providing a coating precursor material, c) providing a solvent, d) providing an adhesion promoter compound; e) blending the coating precursor material and the solvent, such that the coating precursor material is substantially solvated, to form a coating composition, f) applying the adhesion promoter to the solder component and f) applying or coupling the coating composition to the solder component.

Solder parts and/or solder materials contemplated herein may be produced by a) providing a solder component, b) providing a coating precursor material, c) providing a solvent, d) providing an adhesion promoter compound; e) blending the coating precursor material and the solvent, such that the coating precursor material is substantially solvated, f) blending the adhesion promoter into the coating precursor material and solvent to form a coating composition and f) applying or coupling the coating composition to the solder component.

Solder materials, coating compositions and other related materials described herein may also be used to produce solder pastes, polymer solders and other solder-based formulations and materials, such as those found in the following Honeywell International Inc.'s issued patents and pending patent applications, which are incorporated herein in their entirety: U.S. patent application Ser. Nos. 09/851,103,60/357,754,60/372,525, 60/396,294, and 09/543,628; and PCT Pending Application Serial No.: PCT/US02/14613, and all related continuations, divisionals, continuation-in-parts and foreign applications. Solder materials, coating compositions and other related materials described herein may also be used as components or to construct electronic-based products, electronic components and semiconductor components. In contemplated embodiments, the alloys disclosed herein may be used to produce BGA spheres, may be utilized in an electronic assembly comprising BGA spheres, such as a bumped or balled die, package or substrate, and may be used as an anode, wire or paste or may also be used in bath form.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

As used herein, the term “electronic component” means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. As used herein, the term “battery” means a device that produces usable amounts of electrical power through chemical reactions. Similarly, rechargeable or secondary batteries are devices that store usable amounts of electrical energy through chemical reactions. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

Thus, specific embodiments and applications of solder materials have been disclosed. It should be apparent, however, to those skilled in the art that many more modifications besides those already described are possible without departing from the inventive concepts herein. Moreover, in interpreting the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A solder material, comprising:
a solder component, and a coating composition coupled to the solder component, wherein the coating composition comprises at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof or at least one monomer that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof.

2. The solder material of claim 1, wherein the solder component comprises at least one solder sphere, at least one solder ball, solder powder, at least one solder preform or a combination thereof.

3. The solder material of claim 2, wherein the solder component comprises at least one solder ball.

4. The solder material of claim 1, wherein the solder component comprises at least one metal.

5. The solder material of claim 4, wherein the at least one metal comprises lead.

6. The solder material of claim 1, wherein the coating composition comprises at least one-non-fluorinated polymer.

7. The solder material of claim 6, wherein the non-fluorinated polymer is an organic polymer.

8. The solder material of claim 1, wherein the solder component comprises a melting temperature, the coating composition comprises a thermal degradation temperature, and wherein the thermal degradation temperature is less than the melting temperature.

9. An electronic component comprising the solder material of claim 1.

10. The solder material of claim 1, further comprising an adhesion promoter.

11. A method of forming solder materials, comprising:
providing a solder component;
providing a coating precursor material;
providing a solvent;
blending the coating precursor material and the solvent, such that the coating precursor material is substantially solvated to form a coating composition; and
applying the coating composition to the solder component, wherein the coating composition comprises at least one monomer, non-fluorinated polymer or a combination thereof, wherein the polymers comprise at least one of the following: an oxygen atom, a halogen atom, a nitrogen atom, a phosphorus atom, an aromatic ring, a transition metal, a cage compound, a hydridosiloxane group or a combination thereof and monomers that comprise at least one of the following: an alcohol group, a ketone group, an ester group, an ether group, an aldehyde group, a halogen atom, a nitrogen atom, a phosphorus atom, a fused aromatic ring, a cage compound, a transition metal, a hydridosiloxane group or a combination thereof.

12. The method of claim 11, further comprising drying or curing the coating composition.

13. The method of claim 11, further comprising drying and curing the coating composition.

14. The method of one of claims 12 or 13, wherein drying the coating composition comprises applying thermal energy to the composition.

15. The method of one of claims 12 or 13, wherein curing the coating composition comprises applying thermal energy to the composition.

16. The method of claim 11, wherein the solder component comprises at least one solder sphere, at least one solder ball, solder powder, at least one solder preform or a combination thereof.

17. The method of claim 16, wherein the solder component comprises at least one solder ball.

18. The method of claim 11, wherein the solder component comprises at least one metal.

19. The method of claim 18, wherein the at least one metal comprises lead.

20. The method of claim 12, wherein the coating composition comprises at least one non-fluorinated polymer.

21. The method of claim 20 wherein the polymer is an organic polymer.

22. The method of claim 11, wherein the solder component comprises a melting temperature, the coating composition comprises a thermal degradation temperature, and wherein the thermal degradation temperature is less than the melting temperature.

23. An electronic component comprising the solder material formed by claim 11.

24. The method of claim 11, further comprising providing an adhesion promoter and blending the adhesion promoter into the coating composition before application to the solder component.

25. A solder material, comprising:
a solder component,
a coating composition, and
an adhesion promoter, wherein the coating composition is coupled to the solder component at least in part by the adhesion promoter.

26. The solder material of claim 25, wherein the solder component comprises at least one solder sphere, at least one solder ball, solder powder, at least one solder preform or a combination thereof.

27. The solder material of claim 26, wherein the solder component comprises at least one solder ball.

28. The solder material of claim 25, wherein the solder component comprises at least one metal.

29. The solder material of claim 28, wherein the at least one metal comprises lead.

30. The solder material of claim 25, wherein the coating composition comprises at least one organic polymer.

31. The solder material of claim 30, wherein the organic polymer comprises polyethylene.

32. The solder material of claim 25, wherein the solder component comprises a melting temperature, the coating composition comprises a thermal degradation temperature, and wherein the thermal degradation temperature is less than the melting temperature.

33. An electronic component comprising the solder material of claim 25.

34. A method of forming solder materials, comprising:
providing a solder component;
providing a coating precursor material;
providing a solvent;
providing an adhesion promoter;
blending the coating precursor material and the solvent, such that the coating precursor material is substantially solvated to form a coating composition;
applying the adhesion promoter to the solder component; and
applying the coating composition to the solder component.

35. The method of claim 34, further comprising drying or curing the coating composition.

36. The method of claim 34, further comprising drying and curing the coating composition.

37. The method of one of claims 35 or 36, wherein drying the coating composition comprises applying thermal energy to the composition.

38. The method of one of claims 35 or 36, wherein curing the coating composition comprises applying thermal energy to the composition.

39. The method of claim 34, wherein the solder component comprises at least one solder sphere, at least one solder ball, solder powder, at least one solder preform or a combination thereof.

40. The method of claim 39, wherein the solder component comprises at least one solder ball.

41. The method of claim 34, wherein the solder component comprises at least one metal.

42. The method of claim 41, wherein the at least one metal comprises lead.

43. The method of claim 34, wherein the coating composition comprises at least one organic polymer.

44. The method of claim 43, wherein the organic polymer comprises polyethylene.

45. The method of claim 34, wherein the solder component comprises a melting temperature, the coating composition comprises a thermal degradation temperature, and wherein the thermal degradation temperature is less than the melting temperature.

46. An electronic component comprising the solder material formed by claim 34.

47. A method of forming solder materials, comprising:
providing a solder component,
providing a coating precursor material,
providing a solvent,
providing an adhesion promoter compound;
blending the coating precursor material and the solvent, such that the coating precursor material is substantially solvated,
blending the adhesion promoter into the coating precursor material and solvent to form a coating composition and
applying or coupling the coating composition to the solder component.

48. The method of claim 47, further comprising drying or curing the coating composition.

49. The method of claim 47, further comprising drying and curing the coating composition.

50. The method of one of claims 48 or 49, wherein drying the coating composition comprises applying thermal energy to the composition.

51. The method of one of claims 48 or 49, wherein curing the coating composition comprises applying thermal energy to the composition.

52. The method of claim 47, wherein the solder component comprises at least one solder sphere, at least one solder ball, solder powder, at least one solder preform or a combination thereof.

53. The method of claim 52, wherein the solder component comprises at least one solder ball.

54. The method of claim 47, wherein the solder component comprises at least one metal.

55. The method of claim 54, wherein the at least one metal comprises lead.

56. The method of claim 47, wherein the coating composition comprises at least one organic polymer.

57. The method of claim 56, wherein the organic polymer comprises polyethylene.

58. The method of claim 47, wherein the solder component comprises a melting temperature, the coating composition comprises a thermal degradation temperature, and wherein the thermal degradation temperature is less than the melting temperature.

59. An electronic component comprising the solder material formed by claim 47.
